(19) United States
(12) Patent Application Publication
(10) Pub. No.: US 2017/0083587 A1
(43) Pub. Date: Mar. 23, 2017

(54) DATA COLLECTING/PROCESSING SYSTEM AND PRODUCT MANUFACTURING/ANALYZING SYSTEM INCLUDING THE SAME

(71) Applicant: Samsung Electronics Co., Ltd., Suwon-si (KR)

(72) Inventors: YEONJUNG KIM, Yongin-si (KR); Sungeun EOM, Seoul (KR); Yujin Shin, Gunpo-si (KR); Yusin Yang, Seoul (KR)

(73) Assignee: Samsung Electronics Co., Ltd., Suwon-si (KR)

(21) Appl. No.: 15/176,667

(22) Filed: Jun. 8, 2016

(30) Foreign Application Priority Data
Sep. 18, 2015 (KR) 10-2015-0132237

(51) Int. Cl. G06F 17/30

(52) U.S. Cl. CPC G06F 17/30528; G06F 17/30292; G06F 17/30554

(57) ABSTRACT

A data collecting/processing system includes a recipe generator configured to define a plurality of recipes based on a user setting signal, each of the plurality of recipes representing one of data collecting schemes and data processing schemes; a register configured to store the plurality of recipes; and an execution part configured to perform a plurality of data collecting operations by obtaining data from an external system, configured to perform a plurality of data processing operations on the obtained data, and configured to provide results of the plurality of data processing operations to the external system, the plurality of data collecting operations and the plurality of data processing operations being performed based on the plurality of recipes and a plurality of job messages for a plurality of products treated by the external system.

### CROSS-REFERENCE TO RELATED APPLICATION

This application claims priority under 35 USC §his application claims priority under 10-2015-0132237, filed on Sep. 18, 2015 in the Korean Intellectual Property Office (KIPO), the contents of which are incorporated herein by reference in their entirety.

### BACKGROUND

1. Technical Field

At least some example embodiments relate generally to data processing, and more particularly to data collecting/processing systems and product manufacturing/analyzing systems including the data collecting/processing systems.

2. Description of the Related Art

Data and/or conditions for manufacturing or analysis of products, such as semiconductor devices, can be managed by electronic systems to improve efficiency, quality, productivity, and return-on-investment. Recently, the number and types of the products have increased, the number of manufacturing processes has increased, and/or a structure of the products has been complex. Researchers are conducting various research projects on techniques of managing and processing the data and/or the conditions for the manufacturing or the analysis of the products.

### SUMMARY

Accordingly, the present disclosure is provided to substantially obviate one or more problems due to limitations and disadvantages of the related art.

According to at least some example embodiments, a data collecting/processing system includes a recipe generator configured to define a plurality of recipes based on a user setting signal, each of the plurality of recipes representing one of data collecting schemes and data processing schemes; a register configured to store the plurality of recipes; and an execution part configured to perform a plurality of data collecting operations by obtaining data from an external system, configured to perform a plurality of data processing operations on the obtained data, and configured to provide results of the plurality of data processing operations to the external system, the plurality of data collecting operations and the plurality of data processing operations being performed based on the plurality of recipes and a plurality of job messages for a plurality of products treated by the external system.

The external system may be configured to manufacture or analyze the plurality of products, and the execution part may include, a listener configured to receive information for the plurality of products from the external system, and configured to generate a first job message for first products, at least one of the plurality of data collecting operations or the plurality of data processing operations being required for the first products, a job manager configured to receive the first job message, and configured to control a transmission of the first job message, a collector configured to obtain first data from the external system based on the first job message and a first collection recipe when a first data collecting operation is required for the first products, the first data being associated with the first products, an executor configured to perform a first calculation on the first data based on the first job message and a first execution recipe when a first data processing operation is required for the first products, the first calculation being associated with the first data processing operation, and a router configured to output first result data to the external system based on the first job message, the first result data being associated with a result of the first data processing operation.

Then the first data collecting operation is required for the first products, the collector may receive the first job message from the job manager, load the first collection recipe from the register based on present step information in the first job message, and obtain the first data based on the first collection recipe, and the present step information may represent a position or a status of the first products in the external system.

When the first data collecting operation is completed, the collector may update a data collection result in the first job message, and returns the first job message to the job manager.

When the first data processing operation is required for the first products, the executor may receive the first job message from the job manager, load the first execution recipe from the register based on present step information in the first job message, and perform the first calculation based on the first execution recipe, and the present step information may represent a position or a status of the first products in the external system.

When the first data processing operation is completed, the executor may update a data calculation result in the first job message, and return the first job message to the job manager, and the router may receive the first job message from the job manager, and output the first result data representing the result of the first data processing operation based on the first job message.

The execution part may further include a data analyzer configured to perform a second calculation on the first data and the result of the first data processing operation based on the first job message and a first analysis recipe when a second data processing operation is required for the first products, the second calculation being associated with the second data processing operation.

When the second data processing operation is required for the first products, the data analyzer may receive the first job message from the job manager, load the first analysis recipe from the register based on present step information in the first job message, and perform the second calculation based on the first analysis recipe, and the present step information may represent a position or a status of the first products in the external system.

When the first data processing operation is completed, the executor may update a data calculation result in the first job message, and return the first job message to the job manager, when the second data processing operation is completed, the data analyzer may update the data calculation result in the first job message, and transmit the first job message to the router, and the router may output the first result data representing a result of the second data processing operation based on the first job message.

The first products may be included in a first lot of the plurality of products, the first job message may include identification (ID) information of the first lot, present step information for the first products, a data collection result for the first products, and a data calculation result for the first products, the present step information may represent a position or a status of the first products in the external system.

The execution part may further include a first database configured to store the ID information of the first lot and the present step information for the first products, a second database configured to store the data collection result for the first products, and a third database configured to store the data calculation result for the first products.

The collector may include a plurality of collecting servers, and the executor may includes a plurality of executing servers, and the execution part may assign the first data collecting operation to one of the plurality of collecting servers, and the execution part may assign the first data processing operation to at least one of the plurality of executing servers.

The job manager may assign the first data collecting operation to a first collecting server that has a least number of allocated jobs.

According to at least some example embodiments of the inventive concepts, a product manufacturing/analyzing system includes a main system; a plurality of equipment items controlled by the main system, the plurality of equipment items configured to operate for manufacturing or analyzing a plurality of products; and a data collecting/processing system including, a recipe generator configured to define a plurality of recipes based on a user setting signal, each of the plurality of recipes representing one of data collecting schemes and data processing schemes, a register configured to store the plurality of recipes, and an execution part configured to perform a plurality of data collecting operations by obtaining data from at least one of the main system or the plurality of equipment items, configured to perform a plurality of data processing operations on the obtained data, and configured to provide results of the plurality of data processing operations to at least one of the main system or the plurality of equipment items, the plurality of data collecting operations and the plurality of data processing operations being performed based on the plurality of recipes and a plurality of job messages for the plurality of products.

The product manufacturing/ analyzing system may further include a plurality of subsystems configured to control the plurality of equipment items, wherein the data collecting/processing system is configured to interwork with the main system, the plurality of equipment items and the plurality of subsystems.

According to at least some example embodiments of the inventive concepts, a data handling system includes memory storing computer-readable instructions; one or more processors configured to execute the instructions such that the one or more processors are configured to, define a plurality of recipes based on a user setting signal, each of the plurality of recipes representing at least one scheme, the at least one scheme being a data collecting scheme or a data processing scheme, perform a plurality of data collecting operations by obtaining data from an external system, perform a plurality of data processing operations on the obtained data, and provide results of the plurality of data processing operations to the external system, the plurality of data collecting operations and the plurality of data processing operations being performed based on the plurality of recipes and a plurality of job messages for a plurality of products treated by the external system.

The data handling system may further include a register that stores the plurality of recipes.

The memory my further store the plurality of recipes.

The one or more processors may be configured to execute the instructions such that the one or more processors are further configured to receive product information corresponding to the plurality of products from the external system.

The one or more processors may be configured to execute the instructions such that the one or more processors are further configured to generate the plurality of job messages based on the received product information.

### BRIEF DESCRIPTION OF THE DRAWINGS

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a block diagram illustrating a data collecting/processing system according to at least some example embodiments of the inventive concepts.

FIG. 2 is a block diagram illustrating an example of an execution part included in the data collecting/processing system according to at least some example embodiments of the inventive concepts.

FIGS. 3, 4, 5 and 6 are diagrams for describing an operation of the execution part of FIG. 2.

FIG. 7 is a block diagram illustrating a data collecting/processing system according to at least some example embodiments of the inventive concepts.

FIG. 8 is a flow chart illustrating a method of collecting/processing data according to at least some example embodiments of the inventive concepts.

FIG. 9 is a flow chart illustrating an example of step S200 in FIG. 8.

FIG. 10 is a flow chart illustrating an example of step S300 in FIG. 8.

FIG. 11 is a flow chart illustrating an example of step S400 in FIG. 8.

FIG. 12 is a block diagram illustrating a product manufacturing/analyzing system according to at least some example embodiments of the inventive concepts.

### DETAILED DESCRIPTION OF THE EMBODIMENTS

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Accordingly, while example embodiments of the inventive concepts are capable of various modifications and alternative forms, embodiments thereof are shown by way of example in the drawings and will herein be described in detail. It should be understood, however, that there is no intent to limit example embodiments of the inventive concepts to the particular forms disclosed, but to the contrary, example embodiments of the inventive concepts are to cover all modifications, equivalents, and alternatives falling within the scope of example embodiments of the inventive concepts. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments of the inventive concepts are described herein with reference to schematic illustrations of idealized embodiments (and intermediate structures) of the inventive concepts. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

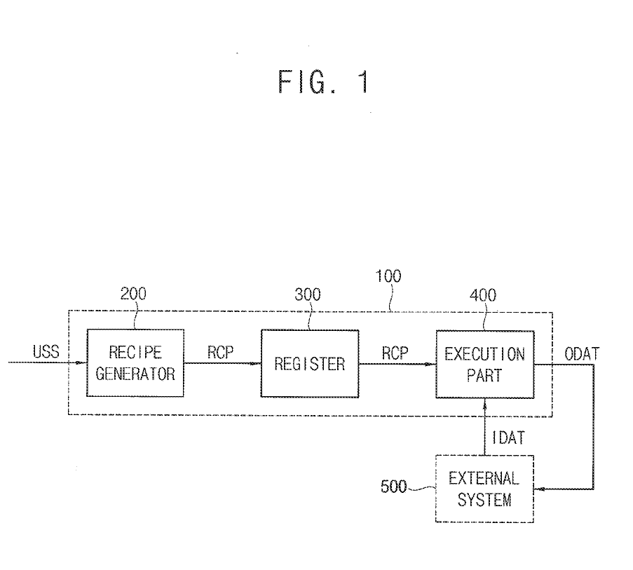

FIG. 1 is a block diagram illustrating a data collecting/processing system according to at least some example embodiments of the inventive concepts. The data collecting/processing system 100 may also be referred to in the present disclosure as a ould be interpreted as

Referring to FIG. 1, a data collecting/processing system 100 includes a recipe generator 200, a register 300 and an execution part 400. As will be discussed in greater detail below, the recipe generator 200 may be or include recipe generator circuitry, and the execution part 400 may be or include execution part circuitry.

According to at least one example embodiment of the inventive concepts, the recipe generator 200 may include or be implemented by one or more circuits or circuitry (e.g., hardware) specifically structured to carry out and/or control some or all of the operations described herein as being performed by the recipe generator 200 (or an element thereof). According to at least one example embodiment of the inventive concepts, the recipe generator 200 may include or be implemented by a memory and one or more processors executing computer-readable code (e.g., software) that is stored in the memory and includes instructions for causing the one or more processors to carry out and/or control some or all of the operations described herein as being performed by the recipe generator 200 (or an element thereof). According to at least one example embodiment of the inventive concepts, the recipe generator 200 may be implemented by, for example, a combination of the above-referenced hardware and processors executing computer-readable code.

According to at least one example embodiment of the inventive concepts, the execution part 400 may include or be implemented by one or more circuits or circuitry (e.g., hardware) specifically structured to carry out and/or control some or all of the operations described herein as being performed by the execution part 400 (or an element thereof). According to at least one example embodiment of the inventive concepts, the execution part 400 may include or be implemented by a memory and one or more processors executing computer-readable code (e.g., software) that is stored in the memory and includes instructions for causing the one or more processors to carry out and/or control some or all of the operations described herein as being performed by the execution part 400 (or an element thereof). According to at least one example embodiment of the inventive concepts, the execution part 400 may be implemented by, for example, a combination of the above-referenced hardware and processors executing computer-readable code.

The data collecting/processing system 100 according to at least some example embodiments of the inventive concepts may interwork with manufacturing, fabrication or analysis of a plurality of products. The plurality of products may be treated (e.g., handled, manufactured, inspected, enhanced and/or fabricated) by an external system 500, and may not be treated by the data collecting/processing system 100. The data collecting/processing system 100 may perform data collecting operations and data processing operations in connection with the external system 500, and may provide results of the data processing operations to the external system 500.

According to at least one example embodiment of the inventive concepts, the external system 500 may include one or more circuits or circuitry (e.g., hardware) specifically structured to carry out and/or control some or all of the operations described herein as being performed by the external system 500 (or an element thereof). According to at least one example embodiment of the inventive concepts, the external system 500 may include a memory and one or more processors executing computer-readable code (e.g., software) that is stored in the memory and includes instructions for causing the one or more processors to carry out and/or control some or all of the operations described herein as being performed by the external system 500 (or an element thereof). According to at least one example embodiment of the inventive concepts, the external system 500 may include, for example, a combination of the above-referenced hardware and processors executing computer-readable code.

The term ‘processor’, as used in the present disclosure, may refer to, for example, a hardware-implemented data processing device having circuitry that is physically structured to execute desired operations including, for example, operations represented as code and/or instructions included in a program. Examples of the above-referenced hardware-implemented data processing device include, but are not limited to, a microprocessor, a central processing unit (CPU), a processor core, a multi-core processor; a multiprocessor, an application-specific integrated circuit (ASIC), and a field programmable gate array (FPGA). Processors executing program code are programmed processors, and thus, are special-purpose computers.

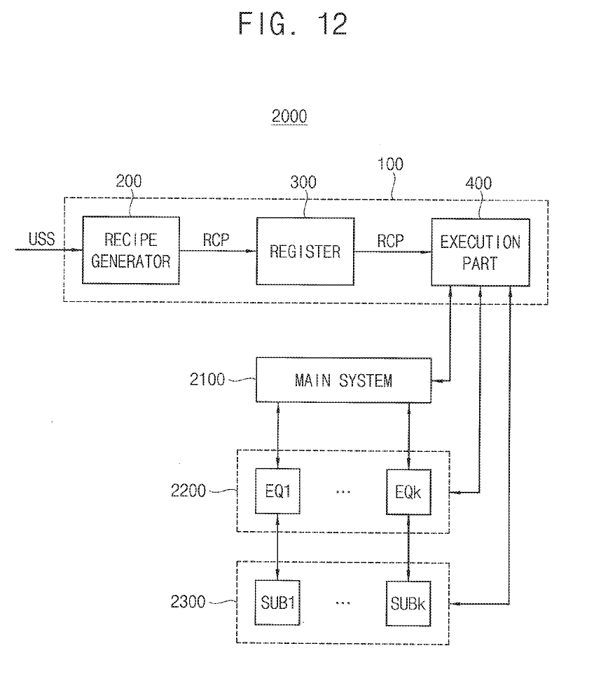

In at least some example embodiments of the inventive concepts, the external system 500 may be a system that manufactures or analyzes the plurality of products. In other words, the external system 500 may be a product manufacturing/analyzing system. For example, the plurality of products may be semiconductor devices (e.g., semiconductor wafers), and the external system 500 may be a system for manufacturing or analyzing the semiconductor devices. As will be described later with reference to FIG. 12, the external system 500 may include a main system and a plurality of equipment items (i.e., equipment or multiple items of equipment).

The recipe generator 200 defines a plurality of recipes RCP based on a user setting signal USS. Each recipe of the plurality of recipes RCP represents one of data collecting schemes and/or data processing schemes. For example, each recipe of the plurality of recipes RCP may represent a unit of minimum logic for a data collecting operation or a data processing operation. As used herein, the term “recipe” may refer to information including computer-readable instructions and or code that may be executed by the execution part 400 and/or a processor to implement one or more operations, one or more schemes and/or logic defined by the recipe.

In at least some example embodiments of the inventive concepts, each of the data collecting schemes may represent a way to obtain desired or, alternatively, required data from one of a plurality of steps in the external system 500. Each of the data processing schemes may represent a way to calculate or analyze the obtained data. Each of the plurality of steps may represent a process in the external system 500 to be performed for manufacturing or analyzing the plurality of products. For example, when the external system 500 is the system for manufacturing or analyzing the semiconductor devices, the plurality of steps may include manufacturing steps, e.g., a photolithography, an etching, an ion implantation, a deposition, a patterning, etc., and/or analysis steps, e.g., a test, a verification, etc.

In at least some example embodiments of the inventive concepts, the user setting signal USS may be provided as a script type (e.g., as a text). In at least some other example embodiments of the inventive concepts, the user setting signal USS may be provided as a macro type that represents an input history or an input order of functional buttons. Alternatively, the user setting signal USS may be provided by connecting unit images or data modules with one another. The recipe generator 200 may determine (or set) the plurality of recipes RCP based on the user setting signal USS provided as one of various types that are generated by a user.

The register 300 determines a plurality of recipe information items associated with the plurality of recipes RCP, and stores the plurality of recipes RCP and the plurality of recipe information items. Alternatively, according to at least some example embodiments, the plurality of recipe items may be included in the plurality of recipes RCP or sent from the recipe generator 200 to the register 300 along with the plurality of recipes RCP. The register 300 may provide at least one of the plurality of recipes RCP to the execution part 400 based on a request of the execution part 400.

In at least some example embodiments of the inventive concepts, the plurality of recipes RCP stored in the register 300 may be used or applied in real time without an additional procedure.

In at least some example embodiments of the inventive concepts, the plurality of recipes RCP may include a plurality of collection recipes, a plurality of execution recipes and a plurality of analysis recipes. The plurality of collection recipes may represent the data collecting schemes, and the plurality of execution recipes and the plurality of analysis recipes may represent the data processing schemes. Although not illustrated in FIG. 1, the register 300 may include a collection recipe pool that stores the plurality of collection recipes, an execution recipe pool that stores the plurality of execution recipes, and an analysis recipe pool that stores the plurality of analysis recipes.

In at least some example embodiments of the inventive concepts, the plurality of recipe information items may include step information corresponding to the plurality of recipes RCP and data types that are collected or processed based on the plurality of recipes RCP. The plurality of recipe information items may further include result types (e.g., protocols) that are used or expressed in the external system 500. For example, a plurality of collection recipe information associated with the plurality of collection recipes may include step information for collecting or obtaining data and obtained data types. A plurality of execution recipe information items associated with the plurality of execution recipes may include step information for calculating data and calculated data types. A recipe information item may be, for example, an item (e.g., unit) of recipe information. A plurality of analysis recipe information items associated with the plurality of analysis recipes may include step information for analyzing data and analyzed data types.

In at least some example embodiments of the inventive concepts, relationships between the plurality of recipes RCP and the plurality of recipe information items may be stored as at least one lookup table. For example, the register 300 may store a collection information table by matching the plurality of collection recipes with the plurality of collection recipe information items, may store an execution information table by matching the plurality of execution recipes with the plurality of execution recipe information items, and may store an analysis information table by matching the plurality of analysis recipes with the plurality of analysis recipe information items. The step information in the collection information table may be substantially the same as or may different from the step information in the execution information table.

In at least some example embodiments of the inventive concepts, several collection recipes may be used or applied for a single step. In this example, data may be searched, collected or obtained from a plurality of sources in the single step.

In at least some example embodiments of the inventive concepts, several execution recipes may be used or applied for a single step. For example, the several execution recipes may be sequentially used or used in parallel with in the single step. In this example, the several execution recipes may be stored as a tree structure.

In at least some example embodiments of the inventive concepts, when a single recipe is used or applied for several steps, the collection information table and the execution information table may be managed based on information other than the step information.

The execution part 400 performs a plurality of data collecting operations by obtaining data IDAT from the external system 500, and performs a plurality of data processing operations on the obtained data IDAT. The plurality of data collecting operations and the plurality of data processing operations are performed based on the plurality of recipes RCP and a plurality of job messages for the plurality of products treated by the external system 500. The execution part 400 provides result data ODAT that are associated with results of the plurality of data processing operations to the external system 500.

In at least some example embodiments of the inventive concepts, the data collecting/processing system 100 may be implemented as a service platform, and then the plurality of recipes RCP may be referred to as a plurality of services.

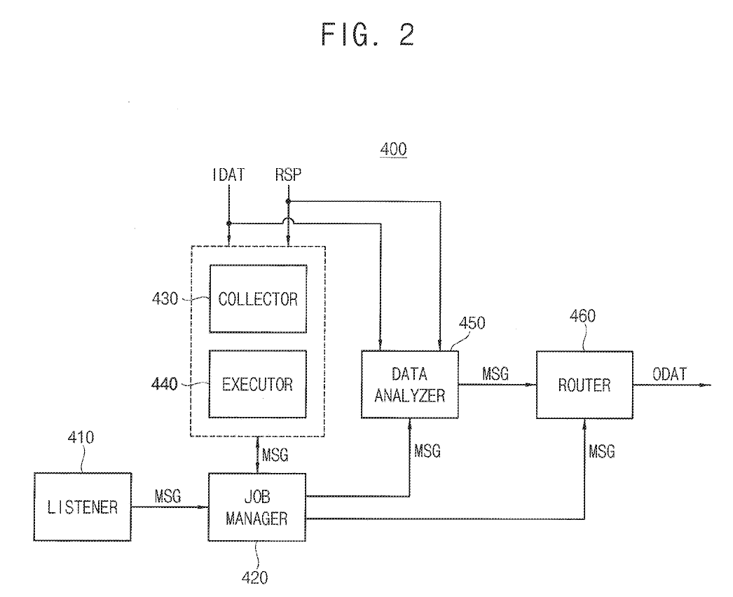

FIG. 2 is a block diagram illustrating an example of an execution part included in the data collecting/processing system according to at least some example embodiments of the inventive concepts.

Referring to FIGS. 1 and 2, the execution part 400 may include a listener 410, a job manager 420, a collector 430, an executor 440 and a router 460. The execution part 400 may further include a data analyzer 450. As is noted above with respect to the execution part 400, the listener 410, job manager 420, collector 430, executor 440 and router 460 may be implemented by, for example, circuitry (e.g., hardware), one or more processors executing computer-readable code, and/or a combination of the above-referenced hardware and one or more processors executing computer-readable code.

The listener 410 may generate a plurality of job messages MSG for the plurality of products. For example, when one of the plurality of data collecting operations and the plurality of data processing operations is required for at least one of the plurality of products, the listener 410 may generate a respective one of the plurality of job messages MSG.

In at least some example embodiments of the inventive concepts, each of the plurality of job messages MSG may be generated in a unit of lot. A single lot may represent a group of products that are manufactured or analyzed in the same condition or environment.

The job manager 420 may receive the plurality of job messages MSG, and may control transmissions of the plurality of job messages MSG. For example, in the job manager 420, the plurality of received job messages MSG may be arranged in a form of queue, and the first job message added to the queue may be the first one to be transmitted to the collector 430, the executor 440 or the data analyzer 450.

The job manager 420 may assign the plurality of data collecting operations and the plurality of data processing operations based on the plurality of job messages MSG. For example, the job manager 420 may transmit one of the plurality of job messages MSG to the collector 430, and then one of the plurality of data collecting operations may be assigned to the collector 430. The job manager 420 may transmit another one of the plurality of job messages MSG to the executor 440 or the data analyzer 450, and then one of the plurality of data processing operations may be assigned to the executor 440 or the data analyzer 450.

The collector 430 may obtain the data IDAT from the external system 500 based on the plurality of job messages MSG and the plurality of recipes RCP (e.g., the plurality of collection recipes). The data IDAT may be associated with the plurality of products. The acquisition of the data IDAT may be selectively performed as needed. The collector 430 may exchange the plurality of job messages MSG with the job manager 420.

The executor 440 may perform calculations on the data IDAT based on the plurality of job messages MSG and the plurality of recipes RCP (e.g., the plurality of execution recipes). The calculations may be associated with the plurality of data processing operations. The executor 440 may exchange the plurality of job messages MSG with the job manager 420.

The data analyzer 450 may perform additional calculations on the data IDAT and results of the calculations by the executor 440 based on the plurality of job messages MSG and the plurality of recipes RCP (e.g., the plurality of analysis recipes). The additional calculations may be associated with the plurality of data processing operations. The additional calculations may be selectively performed as needed.

The router 460 may receive the plurality of job messages MSG from the job manager 420 or the data analyzer 450, and may output the result data ODAT to the external system 500 based on the plurality of job messages MSG.

Based on the data collecting/processing system 100 according to at least some example embodiments of the inventive concepts, logics that are appropriate to the external system 500 may be developed or applied without any restrictions, raw data in the external system 500 may be easily searched or accessed, the raw data may be processed in a number of different ways, the processed data may be returned to the external system 500, and various data may be utilized for manufacturing or analyzing the products. Accordingly, the data collecting/processing system 100 that interworks with manufacturing or analysis of the products may efficiently manage and process data, and thus the external system 500 may have a relatively high efficiency and productivity.

Hereinafter, an operation (e.g., the data collecting operation and/or the data processing operation) of the data collecting/processing system 100 based on one of the plurality of job messages MSG will be explained in detail.

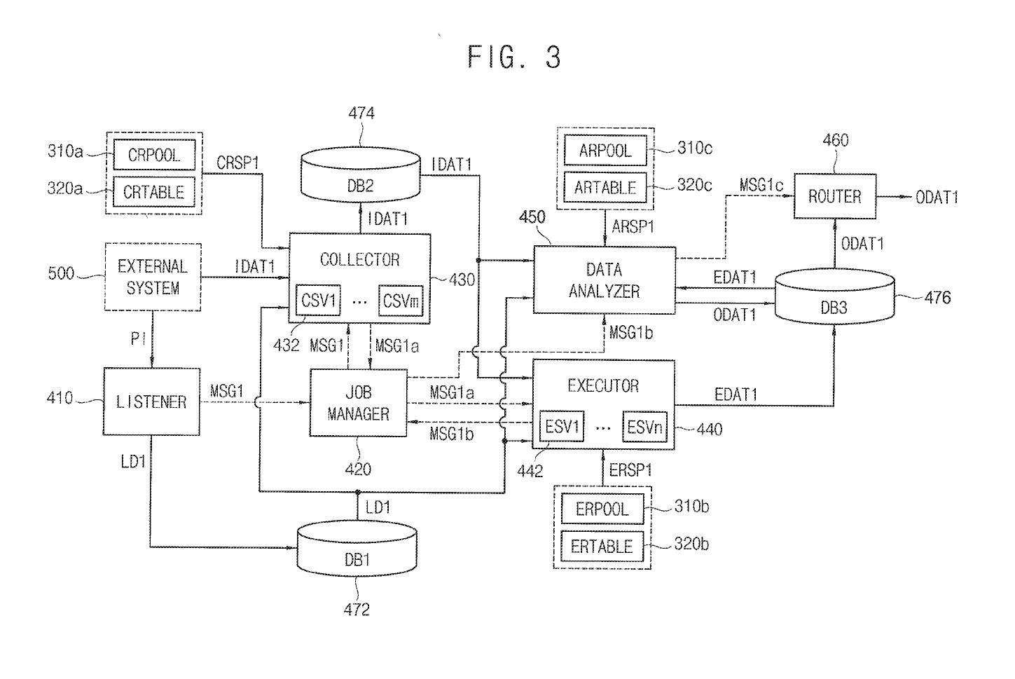

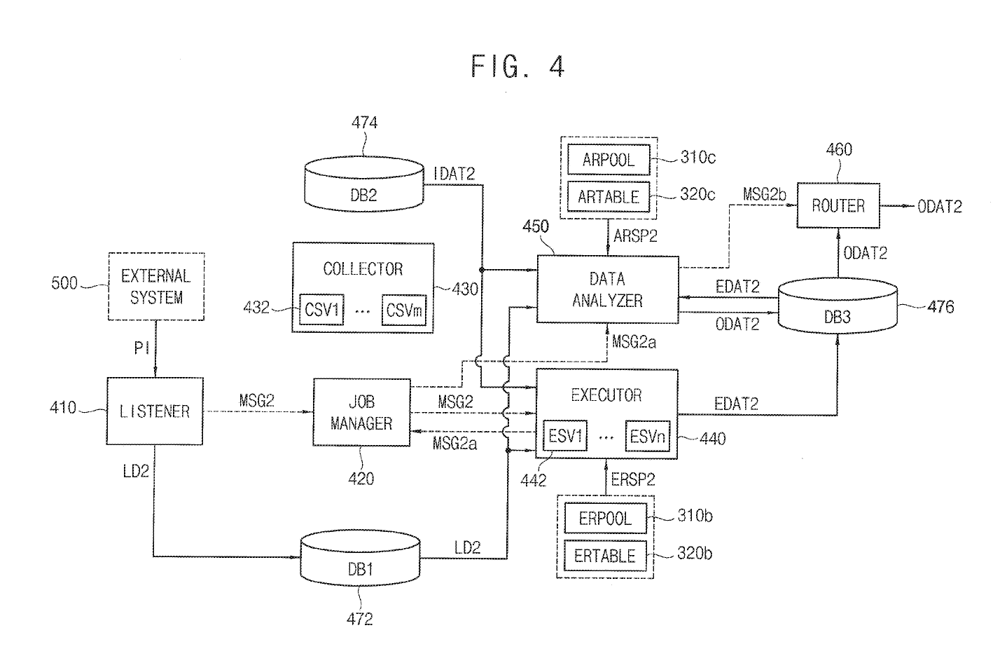

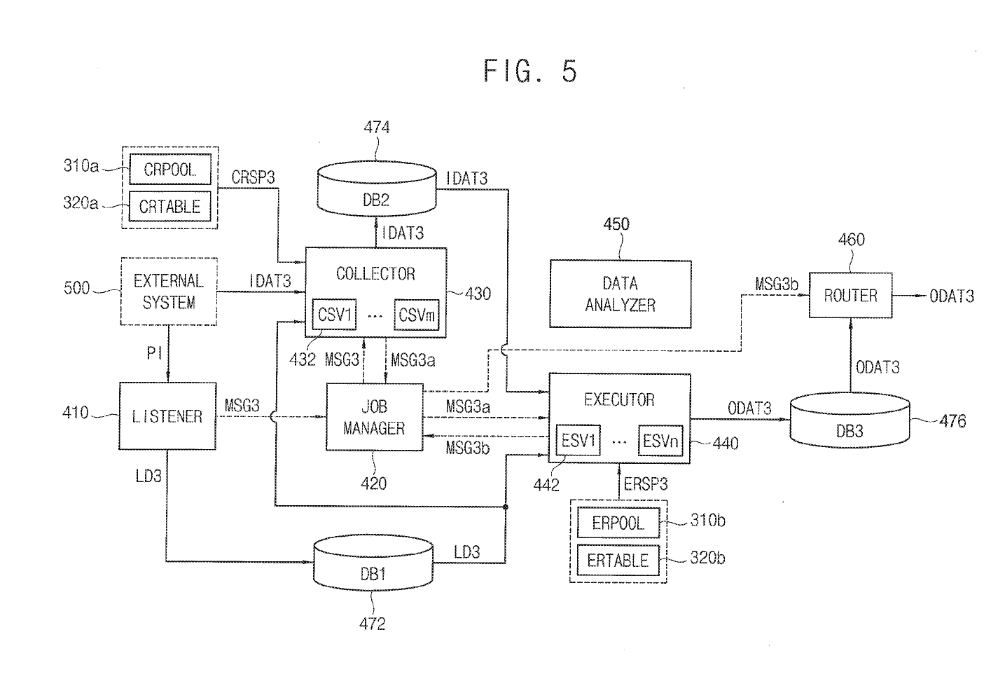

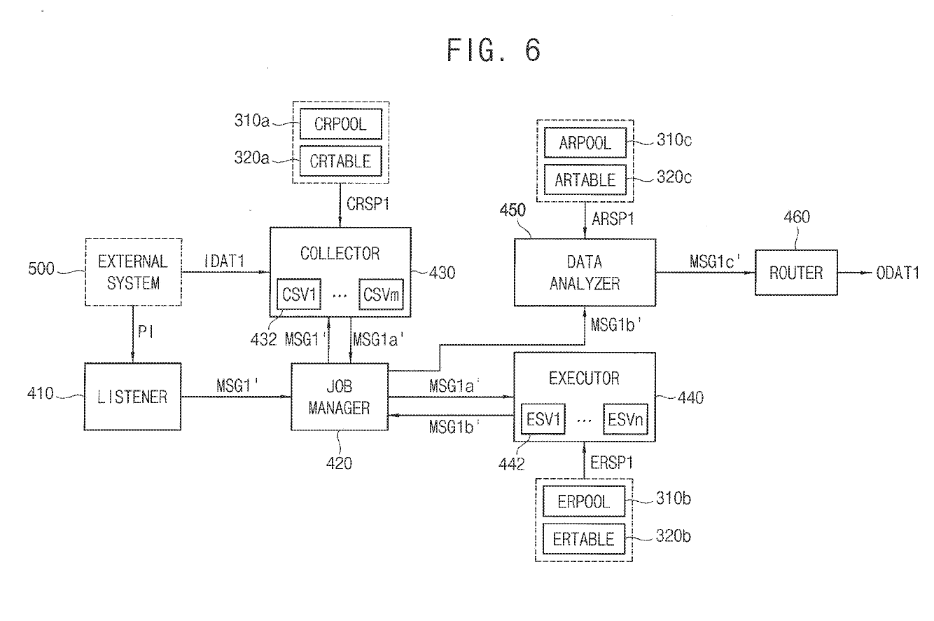

FIGS. 3, 4, 5 and 6 are diagrams for describing an operation of the execution part of FIG. 2. FIGS. 3 and 6 illustrate examples where all of data collection, initial calculating (e.g. initial calculation) and additional calculating (e.g., additional calculation) are performed. FIG. 4 illustrates an example where the data collection is omitted and where the initial calculating and the additional calculating are performed. FIG. 5 illustrates an example where the additional calculating are omitted and where the data collection and the initial calculating are performed.

Referring to FIG. 3, the listener 410 may receive information PI for the plurality of products from the external system 500, and may generate a first job message MSG1 for first products among the plurality of products, for example, based on the received information PI. A first data collecting operation, a first data processing operation and an additional data processing operation may be required (e.g., expected to be performed) for the first products.

In at least some example embodiments of the inventive concepts, the first products may be included in a first lot of the plurality of products. The first job message MSG1 may include identification (ID) information of the first lot, present step information for the first products, a data collection result for the first products, and a data calculation result for the first products.

The present step information for the first products may represent a position or a status of the first products in the external system 500. In other words, the present step information for the first products may be associated with a present step that is currently performed for the first products in the external system 500. The present step information for the first products may include a name of the present step, a starting time of the present step, an ending time of the present step, equipment information used in the present step, etc. The data collection result for the first products may include collected data, a type of data collection, a finish time of the data collection, etc. It may be checked, based on the finish time, whether the data collection is completed. The data calculation result for the first products may include calculated data, a finish time of data calculation, etc. It may be checked, based on the finish time, whether the data calculation is completed. For example, according to at least some example embodiments of the inventive concepts, the execution part 400 may determine whether the data collection and/or the data calculation are complete based on the finish time.

In at least some example embodiments of the inventive concepts, when the first job message MSG1 is initially generated by the listener 410, at least one of the data collection result and the data calculation result may not be recorded (e.g., may be empty) in the first job message MSG1.

The job manager 420 may receive the first job message MSG1, and may determine based on the first job message MSG1 whether the first data collecting operation is required for the first products. For example, when the data collection result for the first products is not recorded in the first job message MSG1, the job manager 420 may determine that the first data collecting operation is required for the first products. When the first data collecting operation is required for the first products, the job manager 420 may transmit the first job message MSG1 to the collector 430, and may assign the first data collecting operation to the collector 430.

The collector 430 may perform the first data collecting operation for the first products. For example, the collector 430 may receive the first job message MSG1 from the job manager 420, and may load a first collection recipe CRSP1 from the register 300 in FIG. 1 based on the present step information in the first job message MSG1. For example, the collector 430 may detect the first collection recipe CRSP1 corresponding to the present step information for the first products by searching a collection information table 320a, and may load the first collection recipe CRSP1 from a collection recipe pool 310a.

The collector 430 may obtain the first data IDAT1 from the external system 500 based on the first collection recipe CRSP1. The first data IDAT1 may be associated with the first products. When the first data collecting operation is completed, the collector 430 may update the data collection result in the first job message MSG1, and may return updated first job message MSG1a to the job manager 420. For example, the data collection result in the updated first job message MSG1a may include the first data IDAT1 and first check data representing whether the data collection is accomplished. The first data collecting operation may be repeated during a desired or, alternatively, predetermined duration (e.g., based on a schedule of manufacturing/analyzing the products or until the data collection is accomplished).

After the first data collecting operation is completed (e.g., after the acquisition of the first data IDAT1 is accomplished), the job manager 420 may transmit the first job message MSG1a, in which the data collection result is updated, to the executor 440, and may assign the first data processing operation to the executor 440. In addition, the job manager 420 may determine whether the additional data processing operation subsequent to the first data processing operation is required for the first products.

The executor 440 may perform the first data processing operation for the first products. For example, the executor 440 may receive the first job message MSG1a from the job manager 420, and may load a first execution recipe ERSP1 from the register 300 in FIG. 1 based on the present step information in the first job message MSG1a. For example, the executor 440 may detect the first execution recipe ERSP1 corresponding to the present step information for the first products by searching an execution information table 320b, and may load the first execution recipe ERSP1 from an execution recipe pool 310b.

The executor 440 may perform a first calculation on the first data IDAT1 based on the first execution recipe ERSP1, and may generate first calculation data EDAT1 based on the first calculation. The first calculation may be associated with the first data processing operation. When the first data processing operation is completed, the executor 440 may update the data calculation result in the first job message MSG1a, and may return updated first job message MSG1b to the job manager 420. For example, the data calculation result in the updated first job message MSG1b may include the first calculation data EDAT1 and second check data representing whether the first calculation is accomplished.

After the first data processing operation is completed (e.g., after the first calculation on the first data IDAT1 is accomplished), the job manager 420 may transmit the first job message MSG1b, in which the data calculation result is updated, to the data analyzer 450, and may assign the additional data processing operation to the data analyzer 450.

The data analyzer 450 may perform the additional data processing operation for the first products. For example, the data analyzer 450 may receive the first job message MSG1b from the job manager 420, and may load a first analysis recipe ARSP1 from the register 300 in FIG. 1 based on the present step information in the first job message MSG1b. For example, the data analyzer 450 may detect the first analysis recipe ARSP1 corresponding to the present step information for the first products by searching an analysis information table 320c, and may load the first analysis recipe ARSP1 from an analysis recipe pool 310c.

The data analyzer 450 may perform an additional calculation on the first data IDAT1 and the first calculation data EDAT1 based on the first analysis recipe ARSP1, and may generate first result data ODAT1 based on the additional calculation. The additional calculation may be associated with the additional data processing operation. When the additional data processing operation is completed, the data analyzer 450 may update the data calculation result in the first job message MSG1b, and may transmit updated first job message MSG1c to the router 460. For example, the data calculation result in the updated first job message MSG1c may include the first result data ODAT1 and third check data representing whether the additional calculation is accomplished.

After the additional data processing operation is completed (e.g., after the additional calculation on the first data IDAT1 and the first calculation data EDAT1 is accomplished), the router 460 may output the first result data ODAT1 representing a result of the additional data processing operation based on the first job message MSG1c and a protocol recoded in one or more of the recipe information items. The first result data ODAT1 may be provided to the external system 500. When at least one of the first data processing operation and the additional data processing operation is failed, the router 460 may output data representing a failure of the calculation.

In at least some example embodiments of the inventive concepts, each of the job messages MSG1, MSG1a, MSG1b and MSG1c may include only an address of actual data. Each of the job messages MSG1, MSG1a, MSG1b and MSG1c may not include the actual data, and the actual data may be stored in a separate storage. For example, the execution part 400 may further include a first database 472, a second database 474 and a third database 476. The first database 472 may store representing the ID information of the first lot and the present step information (e.g., the name, the starting time, the ending time, the equipment information, etc.) for the first products. The ID information and the present step information may be stored as first lot data LD1. The second database 474 may store the data collection result (e.g., the collected data IDAT1, the type of the data collection, the finish time, etc.) for the first products. The third database 476 may store the data calculation result (the calculated data EDAT1 and ODAT1, the finish time, etc.) for the first products. The data LD1, IDAT1, EDAT1 and ODAT1 stored in the databases 472, 474 and 476 may be provided to at least one of the collector 430, the executor 440, the data analyzer 450 and the router 460 based on the job messages MSG1, MSG1a, MSG1b and MSG1c. In FIG. 3, transmissions of messages may be illustrated as arrows with dotted lines, and transmissions of data may be illustrated as arrows with solid lines.

In at least some example embodiments of the inventive concepts, the collector 430 may include a plurality of collecting servers 432, and the executor 440 may include a plurality of executing servers 442. The number of the collecting servers 432 and the number of the executing servers 442 may be changed according to at least some example embodiments of the inventive concepts. The first data collecting operation may be assigned to one of the plurality of collecting servers 432. The first data processing operation may be assigned to at least one of the plurality of executing servers 442. For example, the job manager 420 may assign the first data collecting operation to one collecting server that has a least job allocation among the plurality of collecting servers 432, and may assign first data processing operation to at least one executing server that has a least job allocation among the plurality of executing servers 442. The job manager 420 may include a server management table that includes a list of the servers 432 and 442 and a workload (e.g., the number of allocated jobs) of the servers 432 and 442. The server management table may be updated in real time.

In at least some example embodiments of the inventive concepts, the plurality of collecting servers 432 may perform the data collecting operations in a unit of lot, and the plurality of executing servers 442 may perform the data processing operations in a unit of product in a single lot. For example, one of the plurality of collecting servers 432 may perform the first data collecting operation for the first products (e.g., for the first lot). One of the plurality of executing servers 442 may perform the first data processing operation for one of the first products.

In at least some example embodiments of the inventive concepts, the first products may be semiconductor devices, and the external system 500 may be a system for manufacturing or analyzing the semiconductor devices. For example, when the present step of the semiconductor devices is a patterning, the first data collecting operation may be an operation in which locations of patterned lines (or wires) are obtained, the first data processing operation may be an operation in which lengths and/or widths of the patterned lines are calculated based on the locations of the patterned lines, and the additional data processing operation may be an operation in which it is determined whether the patterned lines are normally or abnormally formed.

Referring to FIG. 4, the listener 410 may receive the information PI for the plurality of products from the external system 500, and may generate a second job message MSG2 for second products among the plurality of products, for example, based on the received information PI. A second data processing operation and an additional data processing operation may be required (e.g., expected to be performed) for the second products.

In at least some example embodiments of the inventive concepts, the second products may be included in a second lot of the plurality of products. The second job message MSG2 may include ID information of the second lot, present step information for the second products, a data collection result for the second products, and a data calculation result for the second products.

The job manager 420 may receive the second job message MSG2, and may determine based on the second job message MSG2 whether a second data collecting operation is required for the second products. For example, when a data collection result for the second products is already recorded in the second job message MSG2 (e.g., when second data IDAT2 associated with the second products is already obtained), or when the second products are in a step in which it is not necessary to obtain data, the job manager 420 may determine that the second data collecting operation is not required for the second products. When the second data collecting operation is not required for the second products, the job manager 420 may not transmit the second job message MSG2 to the collector 430, and the collector 430 may not perform the second data collecting operation.

When the second data collecting operation is not required for the second products, the job manager 420 may transmit the second job message MSG2 to the executor 440, and may assign the second data processing operation to the executor 440. In addition, the job manager 420 may determine whether the additional data processing operation subsequent to the second data processing operation is required for the second products.

The executor 440 may perform the second data processing operation for the second products. For example, the executor 440 may receive the second job message MSG2 from the job manager 420, and may load a second execution recipe ERSP2 from the register 300 in FIG. 1 based on the present step information in the second job message MSG2. The executor 440 may perform a second calculation on the second data IDAT2 based on the second execution recipe ERSP2, and may generate second calculation data EDAT2 based on the second calculation. The second calculation may be associated with the second data processing operation. When the second data processing operation is completed, the executor 440 may update the data calculation result in the second job message MSG2, and may return updated second job message MSG2a to the job manager 420.

After the second data processing operation is completed, the job manager 420 may transmit the second job message MSG2a, in which the data calculation result is updated, to the data analyzer 450, and may assign the additional data processing operation to the data analyzer 450.

The data analyzer 450 may perform the additional data processing operation for the second products. For example, the data analyzer 450 may receive the second job message MSG2a from the job manager 420, and may load a second analysis recipe ARSP2 from the register 300 in FIG. 1 based on the present step information in the second job message MSG2a. The data analyzer 450 may perform an additional calculation on the second data IDAT2 and the second calculation data EDAT2 based on the second analysis recipe ARSP2, and may generate second result data ODAT2 based on the additional calculation. The additional calculation may be associated with the additional data processing operation. When the additional data processing operation is completed, the data analyzer 450 may update the data calculation result in the second job message MSG2a, and may transmit updated second job message MSG2b to the router 460.

After the additional data processing operation is completed, the router 460 may output the second result data ODAT2 representing a result of the additional data processing operation based on the second job message MSG2b and a protocol recoded in one or more of the recipe information items. The second result data ODAT2 may be provided to the external system 500.

Referring to FIG. 5, the listener 410 may receive the information PI for the plurality of products from the external system 500, and may generate a third job message MSG3 for third products among the plurality of products, for example, based on the received information PI. A third data collecting operation and a third data processing operation may be required (e.g., expected to be performed) for the third products.

In at least some example embodiments of the inventive concepts, the third products may be included in a third lot of the plurality of products. The third job message MSG3 may include ID information of the third lot, present step information for the third products, a data collection result for the third products, and a data calculation result for the third products.

The job manager 420 may receive the third job message MSG3, and may determine based on the third job message MSG3 whether the third data collecting operation is required for the third products. For example, when the data collection result for the third products is not recorded in the third job message MSG3, the job manager 420 may determine that the third data collecting operation is required for the third products. When the third data collecting operation is required for the third products, the job manager 420 may transmit the third job message MSG3 to the collector 430, and may assign the third data collecting operation to the collector 430.

The collector 430 may perform the third data collecting operation for the third products. For example, the collector 430 may receive the third job message MSG3 from the job manager 420, and may load a third collection recipe CRSP3 from the register 300 in FIG. 1 based on the present step information in the third job message MSG3. The collector 430 may obtain third data IDAT3 from the external system 500 based on the third collection recipe CRSP3. The third data IDAT3 may be associated with the third products. When the third data collecting operation is completed, the collector 430 may update the data collection result in the third job message MSG3, and may return updated third job message MSG3a to the job manager 420.

After the third data collecting operation is completed, the job manager 420 may transmit the third job message MSG3a, in which the data collection result is updated, to the executor 440, and may assign the third data processing operation to the executor 440. In addition, the job manager 420 may determine whether an additional data processing operation subsequent to the third data processing operation is required for the third products.

The executor 440 may perform the third data processing operation for the third products. For example, the executor 440 may receive the third job message MSG3a from the job manager 420, and may load a third execution recipe ERSP3 from the register 300 in FIG. 1 based on the present step information in the third job message MSG3a. The executor 440 may perform a third calculation on the third data IDAT3 based on the third execution recipe ERSP3, and may generate third result data ODAT3 based on the third calculation. The third calculation may be associated with the third data processing operation. When the third data processing operation is completed, the executor 440 may update the data calculation result in the third job message MSG3a, and may return updated third job message MSG3b to the job manager 420.

After the third data processing operation is completed, and when the additional data processing operation is not required for the third products, the job manager 420 may transmit the third job message MSG3b to the router 460. The router 460 may output the third result data ODAT3 representing a result of the third data processing operation based on the third job message MSG3b and a protocol recoded in one or more of the recipe information items. The third result data ODAT3 may be provided to the external system 500.

Although FIG. 4 illustrates an example where the acquisition of the data is omitted, and although FIG. 5 illustrates an example where the additional calculation is omitted, both the acquisition of the data and the additional calculation may be omitted in the data collecting/processing system 100 according to at least some example embodiments of the inventive concepts.

Referring to FIG. 6, the listener 410, the job manager 420, the collector 430, the executor 440, the data analyzer 450 and the router 460 may perform the first data collecting operation, the first data processing operation and the additional data processing operation for the first products based on job messages MSG1′, MSG1a′, MSG1b′ and MSG1c′.

An example of FIG. 6 may be substantially the same as an example of FIG. 3, except that the example of FIG. 6 does not include the databases 472, 474 and 476 in FIG. 3 that store the data LD1, IDAT1, EDAT1 and ODAT1. In other words, different from the job messages MSG1, MSG1a, MSG1b and MSG1c in FIG. 3, the job messages MSG1′, MSG1a′, MSG1b′ and MSG1c′ in FIG. 6 may include actual data. In the example of FIG. 6, the data LD1, IDAT1, EDAT1 and ODAT1 may be provided to at least one of the collector 430, the executor 440, the data analyzer 450 and the router 460 along with the job messages MSG1′, MSG1a′, MSG1b′ and MSG1c′. Thus, in FIG. 6, transmissions of messages may be illustrated as arrows with solid lines.

Although FIGS. 3, 4, 5 and 6 illustrate examples where the data collecting operation and/or the data processing operation are performed based on a single job message, a plurality of data collecting operations and/or a plurality of data processing operations may be simultaneously or sequentially performed based on a plurality of job messages and relationships (e.g., priority, type, etc.) thereof.

For example, the job manager 420 may simultaneously or sequentially assign a plurality of jobs or tasks (e.g., the plurality of data collecting operations and/or a plurality of data processing operations) to the collector 430, the executor 440 and the data analyzer 450. For example, the job manager 420 may divide a single job into a plurality of sub-jobs, and may assign the plurality of sub jobs to the collector 430, the executor 440 and the data analyzer 450. The single job may be completed when all of the sub-jobs are completed. When the plurality of sub jobs are defined as a tree structure, the job manager 420 may assign lower level sub-jobs, and then may assign upper level sub-jobs after the lower level sub-jobs are assigned.

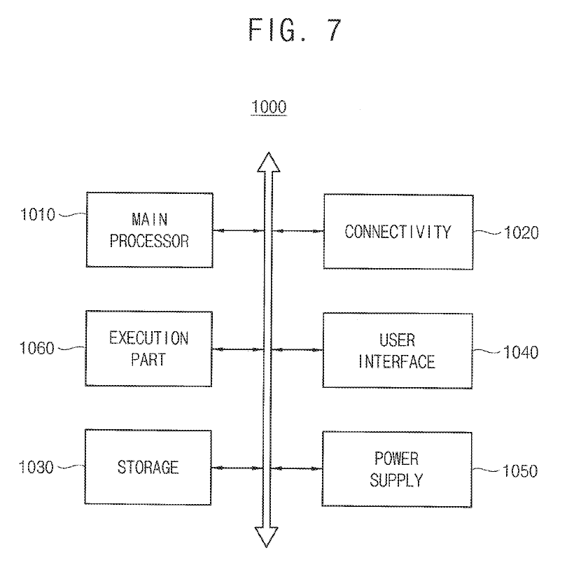

FIG. 7 is a block diagram illustrating a data collecting/processing system according to at least some example embodiments of the inventive concepts.

Referring to FIG. 7, a data collecting/processing system 1000 includes a processor 1010, storage (e.g., memory) 1030 and an execution part 1060. The data collecting/processing system 1000 may further include a connectivity 1020, a user interface 1040 and a power supply 1050.

The processor 1010 may perform various computational functions such as particular calculations and tasks. For example, the processor 1010 may be a central processing unit (CPU), a microprocessor, an application processor (AP), etc. The processor 1010 may execute an operating system (OS) to drive the data collecting/processing system 1000, and may execute various applications and/or software.

In at least some example embodiments of the inventive concepts, the processor 1010 may include a single processor core or multiple processor cores. In at least some example embodiments of the inventive concepts, the processor 1010 may further include a cache memory that is located inside or outside the processor 1010.

The storage 1030 may operate as a data storage for data processed by the processor 1010 or a working memory. For example, the storage 1030 may store a boot image for booting the data collecting/processing system 1000, a file system for the OS to drive the data collecting/processing system 1000, a device driver for an external device connected to the data collecting/processing system 1000, and/or the applications executed by the data collecting/processing system 1000.

In at least some example embodiments of the inventive concepts, the storage 1030 may include a volatile memory such as a dynamic random access memory (DRAM), a static random access memory (SRAM), etc., a non-volatile memory such as an electrically erasable programmable read-only memory (EEPROM), a flash memory, a phase change random access memory (PRAM), a resistance random access memory (RRAM), a magnetic random access memory (MRAM), a ferroelectric random access memory (FRAM), a nano floating gate memory (NFGM), or a polymer random access memory (PoRAM), etc., and/or any storage such as a memory card, a solid state drive (SSD), a hard disk drive (HDD), a CD-ROM, etc.

In at least some example embodiments of the inventive concepts, the recipe generator 200 in FIG. 1 may be included in (e.g., may be embodied by) the processor 1010, and the register 300 in FIG. 1 may be included in the storage 1030. For example, at least a portion of the recipe generator 200 may be implemented with hardware embodied in the processor 1010. For another example, at least a portion of operations of the recipe generator 200 may be performed by instructions (e.g., a software program) that are installed in the data collecting/processing system 1000, are executed by the processor 1010, and are stored in the memory device 1030. The recipe generator 200 may perform functions of generating, storing, loading and executing the recipes RCP. The recipes RCP and one or more of the recipe information items may be stored in the storage 1030.

The execution part 1060 may be similar to the execution part 400 in FIG. 1. For example, the execution part 1060 may include the job manager 420 in FIG. 2, the collector 430 in FIG. 2, the executor 440 in FIG. 2 and the data analyzer 450 in FIG. 2, and may operate based on the examples of FIGS. 3, 4, 5 and 6. In the same manner noted above with respect to the execution part 400, according to at least some example embodiments of the inventive concepts, the execution part 1060 may be implemented by, for example, circuitry (e.g., hardware), one or more processors executing computer-readable code, and/or a combination of the above-referenced hardware and one or more processors executing computer-readable code. Thus, according to at least some example embodiments, the execution part 1060 may be or include execution part circuitry.

The connectivity 1020 may include hardware for communicating with an external device. For example, the connectivity 1020 may include the listener 410 in FIG. 2 and the router 460 in FIG. 2. For example, the connectivity 1020 may include communications circuitry for communicating according to one of various types of protocols such as universal serial bus (USB), Ethernet, near field communication (NFC), radio frequency identification (RFID), a mobile telecommunication like 4G and LTE, a memory card interface. For example, the connectivity 1020 may include a baseband chipset, and may support a communication such as GSM, GPRS, WCDMA, or HSxPA, etc.

The user interface 1040 may include at least one input device such as a keypad, a button, a microphone, a touch screen, etc., and/or at least one output device such as a speaker, a display device, etc. For example, the user setting signal USS in FIG. 1 may be generated based on a control of the user interface 1040. The power supply 1050 may provide power to the data collecting/processing system 1000.

According to at least some example embodiments of the inventive concepts, the data collecting/processing system 1000 and/or components of the data collecting/processing system 1000 may be packaged in various forms, such as a package on package (PoP), a ball grid arrays (BGA), a chip scale packages (CSP), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flat pack (TQFP), a small outline IC (SOIC), a shrink small outline package (SSOP), a thin small outline package (TSOP), a system in package (SIP), a multi chip package (MCP), a wafer-level fabricated package (WFP), or a wafer-level processed stack package (WSP).

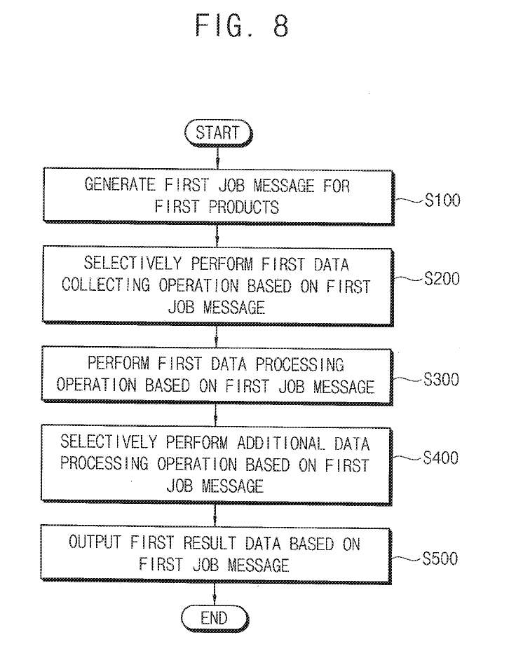

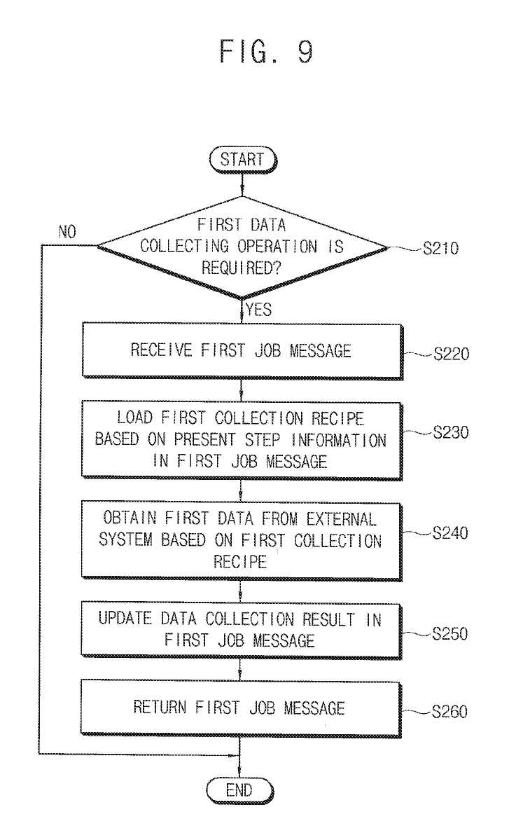

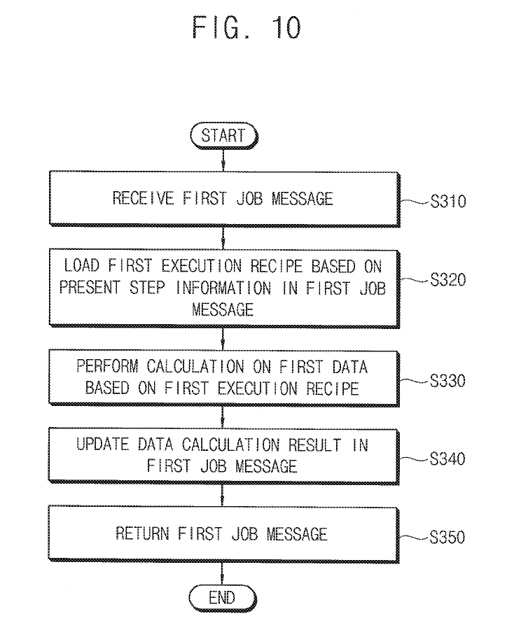

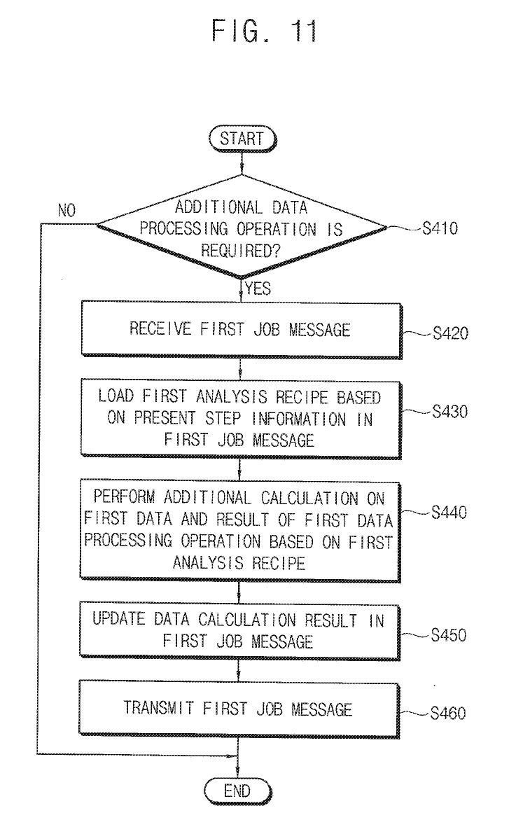

FIG. 8 is a flow chart illustrating a method of collecting/processing data according to at least some example embodiments of the inventive concepts. The method of FIG. 8 may be performed by the data collecting/processing system 100 of FIG. 1, and particularly by the execution part 400 of FIG. 2. FIG. 9 is a flow chart illustrating an example of step S200 in FIG. 8. FIG. 10 is a flow chart illustrating an example of step S300 in FIG. 8. FIG. 11 is a flow chart illustrating an example of step S400 in FIG. 8.

In the method of collecting/processing data according to at least some example embodiments of the inventive concepts, a plurality of recipes RCP in FIG. 1 may be predefined and stored before data collecting operations and data processing operations that are interworked with manufacturing, fabrication or analysis of a plurality of products. Each of the plurality of recipes RCP represents one of data collecting schemes and data processing schemes.

Referring to FIG. 8, the listener 410 may receive information PI for a plurality of products from the external system 500 (e.g., a product manufacturing/analyzing system), and may generate a first job message for first products among the plurality of products (step S 100), for example, based on the received information PI. According to at least some example embodiments of the inventive concepts, at least one selected from a plurality of data collecting operations and a plurality of data processing operations may be required for the first products.

The collector 430 may selectively perform a first data collecting operation for the first products based on the first job message (step S200).

For example, referring to FIG. 9, the job manager 420 may determine based on the first job message whether the first data collecting operation is required for the first products (step S210).

As illustrated in FIG. 3, when the first data collecting operation is required for the first products (step S210: YES), the job manager 420 may transmit the first job message to the collector 430. In other words, the collector 430 may receive the first job message from the job manager 420 (step S220). The collector 430 may load a first collection recipe from the register 300 in FIG. 1 based on present step information in the first job message (step S230). The first collection recipe may correspond to the first data collecting operation. The collector 430 may obtain first data from the external system 500 based on the first collection recipe (step S240). The first data may be associated with the first products. When the first data collecting operation is completed, the collector 430 may update a data collection result in the first job message (step S250), and may return updated first job message to the job manager 420 (step S260).

As illustrated in FIG. 4, when the first data collecting operation is not required for the first products (step S210: NO), the job manager 420 may not transmit the first job message to the collector 430. The collector 430 may not perform the first data collecting operation for the first products.

Referring back to FIG. 8, the executor 440 may perform a first data processing operation for the first products based on the first job message (step S300).

For example, referring to FIG. 10, after the first data collecting operation is completed, or when the first data collecting operation is not required for the first products, the job manager 420 may transmit the first job message to the executor 440. In other words, the executor 440 may receive the first job message from the job manager 420 (step S310). The executor 440 may load a first execution recipe from the register 300 in FIG. 1 based on the present step information in the first job message (step S320). The first execution recipe may correspond to the first data processing operation. The executor 440 may perform a first calculation on the first data based on the first execution recipe (step S330). When the first data processing operation is completed, the executor 440 may update a data calculation result in the first job message (step S340), and may return updated first job message to the job manager 420 (step S350).

Referring back to FIG. 8, the data analyzer 450 may selectively perform an additional data processing operation for the first products based on the first job message (step S400).

For example, referring to FIG. 11, the job manager 420 may determine based on the first job message whether the additional data processing operation is required for the first products (step S410).

As illustrated in FIG. 3, when the additional data processing operation is required for the first products (step S410: YES), the job manager 420 may transmit the first job message to the data analyzer 450. In other words, the data analyzer 450 may receive the first job message from the job manager 420 (step S420). The data analyzer 450 may load a first analysis recipe from the register 300 in FIG. 1 based on the present step information in the first job message (step S430). The first analysis recipe may correspond to the additional data processing operation. The data analyzer 450 may perform an additional calculation on the first data IDAT1 and a result of the first data processing operation based on the first analysis recipe (step S440). When the additional data processing operation is completed, the data analyzer 450 may update the data calculation result in the first job message (step S450), and may transmit updated first job message to the router 460 (step S460).

As illustrated in FIG. 5, when the additional data processing operation is not required for the first products (step S410: NO), the job manager 420 may not transmit the first job message to the data analyzer 450, and may transmit the first job message to the router 460. The data analyzer 450 may not perform the additional data processing operation for the first products.

Referring back to FIG. 8, the router 460 may output first result data based on the first job message and a protocol recoded in one or more of the recipe information items. The first result data may be provided to the external system 500. The first result data may represent the result of the first data processing operation or a result of the additional data processing operation.

FIG. 12 is a block diagram illustrating a product manufacturing/analyzing system according to at least some example embodiments of the inventive concepts.

Referring to FIG. 12, a product manufacturing/analyzing system 2000 includes a main system 2100, a plurality of equipment items 2200 and a data collecting/processing system 100. The product manufacturing/analyzing system 2000 may further include a plurality of subsystems 2300.

The main system 2100 controls overall operations of the product manufacturing/analyzing system 2000. For example, the main system 2100 may control and manage all of steps, conditions, operations, etc. that are associated with manufacturing, fabrication or analysis of a plurality of products. As is noted above with respect to the external system 500, according to at least some example embodiments of the inventive concepts, the main system 2100 may include and/or be implemented by, for example, circuitry (e.g., hardware), one or more processors executing computer-readable code, and/or a combination of the above-referenced hardware and one or more processors executing computer-readable code. Accordingly, the main system 2100 may be or include main system circuitry.

The plurality of equipment items 2200 are controlled by the main system 2100. The plurality of equipment items 2200 operate for manufacturing or analyzing the plurality of products.

In at least some example embodiments of the inventive concepts, the plurality of products that are manufactured or analyzed by the product manufacturing/analyzing system 2000 may be semiconductor devices. In this example, the product manufacturing/analyzing system 2000 may be a system for manufacturing or analyzing the semiconductor devices. The plurality of equipment items 2200 may include, for example, photolithography equipment, etching equipment, ion implantation equipment, deposition equipment, patterning equipment, etc.

The plurality of subsystems 2300 may control the plurality of equipment items 2200. For example, each of the plurality of subsystems 2300 may control a respective one of the plurality of equipment items 2200.

The data collecting/processing system 100 may be substantially the same as the data collecting/processing system 100 of FIG. 1. The data collecting/processing system 100 may include a recipe generator 200, a register 300 and an execution part 400, and may interwork with at least one selected from the main system 2100, the plurality of equipment items 2200 and the plurality of subsystems 2300.

Based on the data collecting/processing system 100 according to at least some example embodiments of the inventive concepts, logics that are appropriate for the systems and equipment 2100, 2200 and 2300 may be developed or applied without any restrictions, raw data in the systems and equipment 2100, 2200 and 2300 may be easily searched or accessed, the raw data may be processed in a number of different ways, the processed data may be returned to the systems and equipment 2100, 2200 and 2300, and various data may be utilized for manufacturing or analyzing the products. Accordingly, the data collecting/processing system 100 that interworks with manufacturing or analysis of the products may efficiently manage and process data, and thus the product manufacturing/analyzing system 2000 may have a relatively high efficiency and productivity.

As will be appreciated by those skilled in the art, at least some example embodiments of the inventive concepts may be embodied as a system, method, and/or one or more computer readable medium(s) having computer readable program code embodied thereon. The computer readable program code may be provided to a processor of a computer thus rendering the computer a special purpose computer. The computer readable program code may also be provided to another programmable data processing apparatus. The computer readable medium may be a computer readable signal medium or a computer readable storage medium. The computer readable storage medium may be any tangible medium that can contain, or store a program for use by or in connection with an instruction execution system, apparatus, or device. For example, the computer readable medium may be a non-transitory computer readable medium.

The present disclosure may be used in any device, equipment or system for manufacturing or analyzing the products, such as an automated manufacturing or analyzing system that treats various products and operates based on an automated schedule.

The foregoing is illustrative of at least some example embodiments of the inventive concepts and is not to be construed as limiting thereof. Although a few example embodiments of the inventive concepts have been described, those skilled in the art will readily appreciate that many modifications are possible in at least some example embodiments of the inventive concepts without materially departing from the novel teachings and advantages of the present disclosure. Accordingly, all such modifications are intended to be included within the scope of the present disclosure as defined in the claims. Therefore, it is to be understood that the foregoing is illustrative of various example embodiments and is not to be construed as limited to the specific example embodiments disclosed, and that all such modifications as would be obvious to one skilled in the art, as well as other example embodiments, are intended to be included within the scope of the appended claims.

What is claimed is:

1. A data collecting/processing system comprising:
a recipe generator configured to define a plurality of recipes based on a user setting signal, each of the plurality of recipes representing one of data collecting schemes and data processing schemes;
a register configured to store the plurality of recipes; and
an execution part configured to perform a plurality of data collecting operations by obtaining data from an external system, configured to perform a plurality of data processing operations on the obtained data, and configured to provide results of the plurality of data processing operations to the external system,
the plurality of data collecting operations and the plurality of data processing operations being performed based on the plurality of recipes and a plurality of job messages for a plurality of products treated by the external system.

2. The data collecting/processing system of claim 1,
wherein the external system is configured to manufacture or analyze the plurality of products, and
wherein the execution part includes,
a listener configured to receive information for the plurality of products from the external system, and configured to generate a first job message for first products, at least one of the plurality of data collecting operations or the plurality of data processing operations being required for the first products,
a job manager configured to receive the first job message, and configured to control a transmission of the first job message,
a collector configured to obtain first data from the external system based on the first job message and a first collection recipe when a first data collecting operation is required for the first products, the first data being associated with the first products,
an executor configured to perform a first calculation on the first data based on the first job message and a first execution recipe when a first data processing operation is required for the first products, the first calculation being associated with the first data processing operation, and
a router configured to output first result data to the external system based on the first job message, the first result data being associated with a result of the first data processing operation.

3. The data collecting/processing system of claim 2,
wherein when the first data collecting operation is required for the first products, the collector receives the first job message from the job manager, loads the first collection recipe from the register based on present step information in the first job message, and obtains the first data based on the first collection recipe, and
wherein the present step information represents a position or a status of the first products in the external system.

4. The data collecting/processing system of claim 3, wherein when the first data collecting operation is completed, the collector updates a data collection result in the first job message, and returns the first job message to the job manager.

5. The data collecting/processing system of claim 2,
wherein when the first data processing operation is required for the first products, the executor receives the first job message from the job manager, loads the first execution recipe from the register based on present step information in the first job message, and performs the first calculation based on the first execution recipe, and
wherein the present step information represents a position or a status of the first products in the external system.

6. The data collecting/processing system of claim 5,
wherein when the first data processing operation is completed, the executor updates a data calculation result in the first job message, and returns the first job message to the job manager, and
wherein the router receives the first job message from the job manager, and outputs the first result data representing the result of the first data processing operation based on the first job message.

7. The data collecting/processing system of claim 2, wherein the execution part further includes a data analyzer configured to perform a second calculation on the first data and the result of the first data processing operation based on the first job message and a first analysis recipe when a second data processing operation is required for the first products, the second calculation being associated with the second data processing operation.

8. The data collecting/processing system of claim 7,
wherein when the second data processing operation is required for the first products, the data analyzer receives the first job message from the job manager, loads the first analysis recipe from the register based on present step information in the first job message, and performs the second calculation based on the first analysis recipe, and
wherein the present step information represents a position or a status of the first products in the external system.

9. The data collecting/processing system of claim 8,
wherein when the first data processing operation is completed, the executor updates a data calculation result in the first job message, and returns the first job message to the job manager,
wherein when the second data processing operation is completed, the data analyzer updates the data calculation result in the first job message, and transmits the first job message to the router, and
wherein the router outputs the first result data representing a result of the second data processing operation based on the first job message.

10. The data collecting/processing system of claim 2,
wherein the first products are included in a first lot of the plurality of products,
wherein the first job message includes identification (ID) information of the first lot, present step information for the first products, a data collection result for the first products, and a data calculation result for the first products,
wherein the present step information represents a position or a status of the first products in the external system.

11. The data collecting/processing system of claim 10, wherein the execution part further includes:
a first database configured to store the ID information of the first lot and the present step information for the first products,
a second database configured to store the data collection result for the first products, and
a third database configured to store the data calculation result for the first products.

12. The data collecting/processing system of claim 2,
wherein the collector includes a plurality of collecting servers, and the executor includes a plurality of executing servers, and
wherein the execution part assigns the first data collecting operation to one of the plurality of collecting servers, and the execution part assigns the first data processing operation to at least one of the plurality of executing servers.

13. The data collecting/processing system of claim 12, wherein the job manager assigns the first data collecting operation to a first collecting server that has a least number of allocated jobs.

14. A product manufacturing/ analyzing system comprising:
a main system;
a plurality of equipment items controlled by the main system, the plurality of equipment items configured to operate for manufacturing or analyzing a plurality of products; and
a data collecting/processing system including,
a recipe generator configured to define a plurality of recipes based on a user setting signal, each of the plurality of recipes representing one of data collecting schemes and data processing schemes,
a register configured to store the plurality of recipes, and
an execution part configured to perform a plurality of data collecting operations by obtaining data from at least one of the main system or the plurality of equipment items, configured to perform a plurality of data processing operations on the obtained data, and configured to provide results of the plurality of data processing operations to at least one of the main system or the plurality of equipment items,
the plurality of data collecting operations and the plurality of data processing operations being performed based on the plurality of recipes and a plurality of job messages for the plurality of products.

15. The product manufacturing/ analyzing system of claim 14, further comprising:
a plurality of subsystems configured to control the plurality of equipment items,
wherein the data collecting/processing system is configured to interwork with the main system, the plurality of equipment items and the plurality of subsystems.

16. A data handling system comprising:
memory storing computer-readable instructions;
one or more processors configured to execute the instructions such that the one or more processors are configured to,
define a plurality of recipes based on a user setting signal, each of the plurality of recipes representing at least one scheme, the at least one scheme being a data collecting scheme or a data processing scheme,
perform a plurality of data collecting operations by obtaining data from an external system,
perform a plurality of data processing operations on the obtained data, and
provide results of the plurality of data processing operations to the external system, the plurality of data collecting operations and the plurality of data processing operations being performed based on the plurality of recipes and a plurality of job messages for a plurality of products treated by the external system.

17. The data handling system of claim 1, further comprising:
a register that stores the plurality of recipes.

18. The data handling system of claim 1, wherein the memory further stores the plurality of recipes.

19. The data handling system of claim 1, wherein the one or more processors configured to execute the instructions such that the one or more processors are further configured to receive product information corresponding to the plurality of products from the external system.

20. The data handling system of claim 19, wherein the one or more processors configured to execute the instructions such that the one or more processors are further configured to generate the plurality of job messages based on the received product information.
